(19) United States
(12) Patent Application Publication
(10) Pub. No.: US 2012/0301555 A1
(43) Pub. Date: Nov. 29, 2012

(54) Pool Water Sanitizer And Method

(76) Inventor: John E. Walls, Kentwood, MI (US)

(21) Appl. No.: 13/557,649

(22) Filed: Jul. 25, 2012

Related U.S. Application Data
(63) Continuation-in-part of application No. 12/761,564, filed on Apr. 16, 2010, now abandoned.

(51) Int. Cl. A01N 59/14; A01P 1/00

(52) U.S. Cl. 424/660

(57) ABSTRACT

A pool water sanitizer composition made of borax hydrate, calcium hypochlorite hydrate, calcium, magnesium, or barium oxide, anhydrous calcium chloride, and sodium, lithium or potassium meta silicate hydrate. The composition is substantially free of intentionally added water, and is produced in a low humidity environment at from about 25% to about 40% relative humidity.

### CROSS REFERENCE TO RELATED APPLICATIONS

This Continuation-In-Part patent application claims priority to U.S. application Ser. No. 12/761,564 filed on Apr. 16, 2010, entitled “Pool Water Sanitizer And Method,” the entire disclosure of the application being considered part of the disclosure of this application and hereby incorporated by reference.

### FIELD OF THE INVENTION

The present invention is generally related to sanitizing compounds for pools, spas and similar bodies of water, and the methods of using same. More specifically, the present invention generally relates to a calcium hypochlorite pool sanitizer.

### BACKGROUND OF THE INVENTION

Calcium hypochlorite is a strong oxidizing agent that is widely used in the treatment of swimming pools, water supplies and the like for controlling algae and bacterial growth. As the primary season for using swimming pools is during warm weather, many times the temperature at which calcium hypochlorite compositions are transported or stored exceed 40° C. which can cause decomposition that reduces the effectiveness of the calcium hypochlorite. In addition, in many areas of the country, high humidity exists during the summer months and as most pool chemicals are stored outdoors and typically exposed to such humidity, the calcium hypochlorite composition may irreversibly harden into a solid block of material. These solid blocks of material may make it difficult to measure out proper quantities of calcium hypochlorite to be added to swimming pools as well as reduce the rate at which the calcium hypochlorite dissolves into the pool water. This hardening of the calcium hypochlorite into a substantially solid block is generally referred to as caking, and is generally undesirable from the perspective of most consumers.

To solve some of the problems with decomposition of calcium hypochlorite at high temperatures, some manufacturers use anhydrous calcium hypochlorite compositions but substantial problems have occurred in that anhydrous calcium hypochlorite compositions tended to suddenly decompose when brought into contact with flames, sparks and organic matters and as such required much more care in transportation and handling. In addition, the anhydrous calcium hypochlorite produced substantial amount of dust which made it difficult to handle by typical consumers such as swimming pool owners. To eliminate these problems, many manufacturers keep a higher water content in the calcium hypochlorite, which makes the composition susceptible to caking, especially if the composition is exposed to higher temperatures.

### SUMMARY OF THE INVENTION

The present invention generally relates to a pool sanitizing compound which is stable at high temperatures and resistant to caking at high humidity. The present invention generally includes a sodium hypochlorite composition formed from 60-80% of calcium hypochlorite hydrate, 5-20% sodium tetraborate, 5-30% calcium oxide and added sodium metasilicate in an amount of up to 10%. The calcium oxide may be substituted with magnesium oxide or barium oxide although calcium oxide is the most preferred. The sodium metasilicate is preferably anhydrous and can be substituted with lithium metasilicate or potassium metasilicate although sodium metasilicate is the most preferred. It is also preferred that both of the sodium tetraborate and sodium metasilicate are anhydrous. The above concentrations produce an average available chlorine of 47.6%.

### DETAILED DESCRIPTION OF THE INVENTION

The present invention is generally directed to an oxidizer which is a product added to pools for controlling algae and bacterial growth. More particularly, the present invention is directed to a calcium hypochlorite oxidizer that is resistant to caking even in humidity and is a stable compound at higher temperatures and is relatively easy for consumers such as pool owners to use. The present invention also provides sanitizing compounds, more particularly a calcium hypochlorite composition that substantially maintains the integrity of its original form such as granules, tablets or pellets and resists caking into large clumps which are difficult to use in treating recreational water. Recreational water as used herein generally refers to any water retained in a created structure where it is desirable to sanitize or disinfect the water to prevent the growth of bacteria, algae and other organisms. Recreational water as further used herein does not include natural features such as lakes, rivers, streams and any other type of body of water where chlorine or other oxidizers are not intentionally added or desirable to be added. Recreational water is used herein specifically excludes drinking water. Examples of structures that retain recreational water include swimming pools, water parks, water slides, and fountains but do not include water features where it is desirable to have fish or amphibians such as a Koi pond.

As stated in the background of the invention, the prior art generally teaches away from using an anhydrous components in making a calcium hypochlorite composition. More specifically, the prior art refers to calcium hypochlorite compositions formed primarily out of anhydrous components as tending to suddenly decompose when brought into contact with flames, sparks or organic matters and difficult to handle due to producing significant amounts of dust that is a strong oxidizer. The present invention has surprisingly found that providing a balance but substantially forming a calcium hypochlorite composition of a calcium hypochlorite hydrate with sodium tetraborate in the anhydrous form, calcium oxide and sodium metasilicate in the anhydrous form provide a stable non-caking and easy to safely handle composition, even though the composition includes anhydrous components. In addition, even when exposed to humidity during the manufacturing process, transport, storage and use by the end consumer, the present invention is resistant to caking and is stable at elevated temperatures. As described above, one of the most significant problems with prior calcium hypochlorite compositions is that they are susceptible to reduced effectiveness when exposed to temperatures above 40° C. which is common in many storage areas such as sheds or barns next to pools and susceptible to caking in humidity such as when the bag is opened and especially when placed near a large source of water such as a swimming pool. In addition, many calcium hypochlorite compositions may cake during the transport from the manufacturer to the distributor or from the distributor to the end user when the manufacturing process occurs with more than 25% especially more than 40% humidity in the ambient air. Therefore, the present invention which is directed to a unique calcium hypochlorite composition provides a composition which avoids the drawbacks of anhydrous forms as provided in the prior art as well as problems with typical calcium hypochlorite compositions of caking and lack of stability.

The present invention is directed to a calcium hypochlorite composition wherein the hypochlorite acts as a source of chlorine and serves as the microstat/microcode and a tetraborate provides a source of boron which has a softening effect on the water and helps control the pH. With the added tetraborate, the calcium hypochlorite composition was even more susceptible to caking and turning into a solid brick of material that could take several days to fully dissolve in recreational water. Therefore, the tetraborate in the past increased the caking problems when exposed to humidity. In comparison, the present invention provides a calcium hypochlorite that also includes a tetraborate that is not susceptible to these caking problems.

The calcium hypochlorite composition generally includes a hydrated calcium hypochlorite specifically (Ca(ClO)₂•2H₂O), an anhydrous sodium tetraborate, a calcium oxide and a sodium metasilicate. The composition at the time of shipment preferably has no intentionally added water, such that the water level at the time of shipment is less than 1% by weight and fillers of less than 5% by weight. In the preferred embodiment, the composition includes 60-80% by weight calcium hypochlorite, 5-20% anhydrous sodium tetraborate, 5-30% calcium oxide, and intentionally added anhydrous sodium metasilicate up to 10%. All weight percentages used are for the dry composition, subject to the water trapped as part of the calcium hypochlorite hydrate. More preferably, the composition includes anhydrous sodium metasilicate in an amount of 0.5 to 10%. In a more preferred example, the composition includes 65-75% by weight calcium hypochlorite, 8-17% by weight anhydrous sodium tetraborate, 10-25% by weight calcium oxide, and 1-5% by weight anhydrous sodium metasilicate. Even more preferably the composition includes 68-72% by weight calcium hypochlorite, 10-14% anhydrous sodium tetraborate, 15-22% calcium oxide, and 1.5-4% anhydrous sodium metasilicate.

The calcium hypochlorite hydrate is typically comprised primarily of the dihydrate form, with some mono-hydrate included. Either the di- or mono-hydrate can be used or mixtures thereof, however, it has been found that the preferable calcium hypochlorite is substantially calcium hypochlorite di-hydrate. The present invention may use in lieu of or in combination with the calcium hypochlorite, sodium hypochlorite, salt of hypochlorite, calcium chlorate, sodium chlorate and calcium hypochlorite, and sodium hypochlorite.

In some instances, such as provided in the claims, sodium tetraborate may be substituted with potassium tetraborate or lithium tetraborate. In all instances, it is preferred that the tetraborate is anhydrous. Anhydrous sodium tetraborate has been found to be the most effective when used in the combination, however, as stated above, some of the others may be substituted as provided in the claims or a combination of sodium tetraborate, lithium tetraborate and/or potassium tetraborate in their anhydrous forms may be used.

Calcium oxide is the most preferred for the composition, however some calcium hydroxide may be present.

The sodium metasilicate is preferably substantially or completely in its anhydrous form, however, in some instances potassium metasilicate or lithium metasilicate may be used in place of or in combination with the sodium metasilicate or each other.

The resulting composition is substantially free of intentionally added water. The term “intentionally added water” does not refer to water of hydration which the composition includes as part of the calcium hypochlorite hydrate component. Instead, intentionally added water is intended to refer to water added over and above the water hydration. In the preferred embodiment, no water beyond the water of hydration is present or is intentionally introduced into the composition. The term “substantially free of intentionally added water” is intended to prevent someone from avoiding infringement of this patent merely by intentionally adding a meaningless quantity of water to the composition. In addition, the term “substantially free” when used in relation to the other components is likewise intended to prevent someone from avoiding infringement by merely intentionally adding minor amounts of filler or minor amounts of a hydrated form in place of the anhydrous forms or substitute in minor amounts of an equivalent chemical composition.

It is of course possible for additional water to be inadvertently added to the product during the manufacturing process such as through absorption or adsorption of moisture from the air. However, to the extent such inadvertent absorption or adsorption is minimized by the manufacturing the product in a low moisture environment such as a low 40% relative humidity or less as part of the preferred manufacturing process.

It is expected that the various ingredients of the composition are blended in powder form. Conventional blenders such as ribbon blenders or tumble mixers can be used. Mill blending or other forms of blending which generate greater mechanical heat than ribbon blenders or tumble mixers are preferably not used unless excessive heat may be avoided. The order of addition of ingredients has not been found to be critical though typically in the method the calcium hypochlorite is added first. As noted above, it is preferable that the composition be prepared in a low humidity environment to prevent unintentional water from being added to the end composition such as in relative humidity below 40%. While not required, it has also been found that blending above 25% relative humidity may avoid creating static electricity during the blending process.

The composition may be sold as a powder, granule, tablet, pellet, or disc form and the ingredients are generally added, where available, in the granular form.

### EXAMPLES

### Example 1

A sample was prepared by adding 70 grams of calcium hypochlorite di-hydrate, 20 grams of sodium tetraborate hydrate (10H₂O), 2 grams of sodium metasilicate (5H₂O), and 8 grams of calcium hydroxide. The blend was mixed for uniformity and placed in a HPDE bottle and capped. This was placed in an oven calibrated to be stable at 150° F. After 24 hours, the sample was removed and evaluated for the ability to free flow and avoid hardening. It was observed that the sample had hardened to the point that it could not be easily broken or chipped. Such a result is consistent with what was experienced with a blend of only calcium hypochlorite and sodium tetraborate, and is not considered commercially acceptable.

### Example 2

In like manner as described in Example 1, another sample was prepared with the exception that the calcium hydroxide was granulated into particles ranging in size from 0.5-1.0 mm Such a result is obtained by using a knurling roll with cells having the desired dimension and about 20 tons of pressure. The sample was placed in the oven for 24 hours. After this time it was observed for hardness. The sample was seen as being hard, but improved over the results realized in Example 1. Although not commercially acceptable, the granulation of the components improved. It is believed that the larger particles reduced the amount of surface area contact, thereby reducing the trend toward caking, however sufficiently small particle size is required to keep the composition evenly mixed as it is used.

### Example 3

A sample was prepared by adding 70 grams of calcium hypochlorite, 2H₂O, 20 grams of sodium tetraborate, 10H₂O, 2 grams of sodium metasilicate, 5H₂O, and 8 grams of granulated calcium oxide (anhydrous lime, CaO versus Ca(OH)₂). The granulation was performed in the same manner as described in Example 2. Upon storage at 150° F. for 24 hours, the sample was observed to be soft but workable more than those from the previous two examples. It was seen as a distinct improvement, but insufficient to be considered as commercially acceptable.

### Example 4

The sample was prepared similar to Example 3 except that anhydrous sodium tetraborate was used in place of the 5 mole hydrated version. The sample was similarly stored at elevated temperature for 24 hours, and was observed to be essentially free flowing. The physical performance is seen as acceptable, but by using anhydrous sodium tetraborate, the boron level was too high for proper performance in a pool environment.

### Example 5

A sample was prepared by blending 70 grams of calcium hypochlorite, 10.6 grams of anhydrous sodium tetraborate, 2 grams of anhydrous sodium metasilicate and 17.4 grams of granulated calcium oxide. Upon 24 hours at the elevated temperature, the product was free flowing and delivered the proper amount of boron to the water. This Example 5 illustrates the advantage of using anhydrous functional components. The elevated amount of calcium oxide required to offset the reduced amount of sodium tetraborate was observed to have no negative influence.

The above examples only provide exemplary findings in forming the composition. The examples illustrate the added surprising benefits of eliminating water as much as possible from the composition such as using anhydrous sodium tetraborate and anhydrous sodium metasilicate in place of the typical hydrated forms, in contradiction to the prior art. From the examples, it is shown that water present as hydration may be released at elevated temperatures during manufacturing, transportation, and storage of the composition and in part, may solubilize the components which in turn may enable an undesirable interaction which results in hardness or caking of the composition. However, it has been found preferable to use granulated versions of the individual components instead of a direct powder which allows the individual components to be further spaced apart significantly reducing areas of surface contact. All components when used in the anhydrous form result in a successful product which overcomes the issues in the prior art. However, it has been found using an anhydrous calcium hypochlorite in addition to anhydrous sodium tetraborate and anhydrous sodium metasilicate is undesirable. It has further been found that using granules or a granulated product for the individual components such as 0.5 to 0.7 mm in diameter allows for increased surface temperatures during manufacturing, distribution, and storage due to the individual components having less contacting surface area and therefore, prevents hardening and caking in addition to the actual chemical composition.

The above provided composition provides at least 30%, preferably at least 35%, more preferably at least 40% and even more preferably, at least 43% available chlorine. If the calcium hypochlorite is used in the most preferred range of 68-72% by weight of the composition such 70% by weight the amount of available chlorine may even exceed 45% and in some instances, even 47% such as having a 47.6% available chlorine. The boron level is 22% of the sodium tetraborate, such that in the preferred example there is about 2.32 grams of boron in the 10.5 grams of the sodium tetraborate.

The compositions made in accordance with the present invention provide excellent sanitizing capacity to a swimming pool, spa or the like. They resist caking upon storage. They are more stable than commercially known hypochlorite containing products under a broader range of conditions. Of course, it is understood that the foregoing are preferred embodiments of the invention and that various changes and alterations can be made without departing from the spirit and broader aspects thereof as set forth in the appended claims.

What is claimed is:

1. A stable non-caking calcium hypochlorite composition comprising:
at least 50% by weight calcium hypochlorite hydrate;
sodium tetraborate;
at least one of calcium oxide, magnesium oxide, and barium oxide; and
at least one of sodium metasilicate, lithium meta silicate, and potassium meta silicate.

2. The composition of claim 1 wherein said composition is free from intentionally added sodium chloride.

3. The composition of claim 1 wherein said sodium tetraborate is substantially anhydrous.

4. The composition of claim 1 wherein said sodium metasilicate is substantially anhydrous.

5. The composition of claim 1 wherein said calcium hypochlorite is Ca(ClO)₂•2H₂O

6. The composition of claim 1 wherein said calcium hypochlorite forms 60-80% by weight.

7. The composition of claim 6 wherein said calcium hypochlorite forms at least 65% by weight.

8. The composition of claim 8 wherein said calcium hypochlorite forms less than or equal to 75% by weight.

9. The composition of claim 6 wherein said calcium hypochlorite forms approximately 68-72% by weight.

10. The composition of claim 1 wherein said sodium tetraborate forms approximately 5-20% by weight.

11. The composition of claim 10 wherein said sodium tetraborate forms at least 8% by weight.

12. The composition of claim 10 wherein said sodium tetraborate is less than or equal to 17% by weight.

13. The composition of claim 10 wherein said sodium tetraborate forms approximately 10-14% by weight.

14. The composition of claim 1 wherein said at least one calcium oxide, magnesium oxide and barium oxide forms 5-30% by weight.

15. The composition of claim 14 wherein said at least one calcium oxide, magnesium oxide and barium oxide forms at least 10% by weight.

16. The composition of claim 14 wherein said at least one calcium oxide, magnesium oxide and barium oxide forms less than or equal to 25% by weight.

17. The composition of claim 14 wherein said at least one calcium oxide, magnesium oxide and barium oxide forms approximately 15-22% by weight.

18. The composition of claim 14 wherein said at least one calcium oxide, magnesium oxide and barium oxide is calcium oxide.

19. The composition of claim 1 wherein said at least one of sodium metasilicate, lithium metasilicate, and potassium metasilicate forms no more than 10% by weight.

20. The composition of claim 1 wherein said at least one of sodium metasilicate, lithium metasilicate, and potassium metasilicate is 0.5-10% by weight.

21. The composition of claim 20 wherein said at least one of sodium metasilicate, lithium metasilicate, and potassium metasilicate is at least 1% by weight.

22. The composition of claim 20 wherein said at least one of sodium metasilicate, lithium metasilicate, and potassium metasilicate is at least 1.5% by weight.

23. The composition of claim 20 wherein said at least one of sodium metasilicate, lithium metasilicate, and potassium metasilicate is less than or equal to 5%.

24. The composition of claim 20 wherein said at least one of sodium metasilicate, lithium metasilicate, and potassium metasilicate is sodium metasilicate.

25. The composition of claim 1 wherein said calcium hypochlorite forms 60-80% by weight, said sodium tetraborate is anhydrous and forms 5-20% by weight, said at least one calcium oxide, magnesium oxide and barium oxide is calcium oxide and forms 5-30% by weight and said at least one of sodium metasilicate, lithium meta silicate, and potassium meta silicate is anhydrous sodium metasilicate and forms 0.5-10% by weight.

26. The composition of claim 23 including less than 5% fillers.

27. A stable non-caking calcium hypochlorite composition comprising:
60-80% by weight calcium hypochlorite hydrate;
sodium tetraborate up to 20% by weight;
calcium oxide up to 30% by weight; and
sodium metasilicate up to 10% by weight.

28. The composition of claim 1 wherein said composition is in the form of at least one of a cake, a pellet and granules.

29. The composition of claim 1 wherein the composition has at least 35% available chlorine.

30. The composition of claim 29 wherein the composition has at least 43% available chlorine.

31. The composition of claim 30 wherein the composition has at least 45% available chlorine.

32. The composition of claim 31 wherein the composition has at least 47% available chlorine.

33. A stable non-caking calcium hypochlorite composition comprising:
at least 50% by weight of at least one selected from the group consisting of calcium hypochlorite, sodium hypochlorite, salt of hypochlorites, calcium chlorate, sodium chlorate and calcium hypochlorite, and sodium hypochlorite;
anhydrous sodium tetraborate in an amount up to 20%;
at least one of calcium oxide, magnesium oxide, and barium oxide; and
at least one of an anhydrous, selected from the group consisting of sodium metasilicate, lithium meta silicate, and potassium meta silicate.
